(19) United States
(12) Patent Application Publication
(10) Pub. No.: US 2005/0194471 A1
(43) Pub. Date: Sep. 8, 2005

(54) Air purge gun flat pattern spray

(76) Inventors: Richard D. Anderson, Maple Grove, MN (US); Peter L. Linder, North Branch, MN (US); Peter M. White, Hamden, CT (US)

Correspondence Address: Douglas B. Farrow, Esquire;Corporate Intellectual Property Counsel, Graco Minnesota Inc., P O Box 1441, Minneapolis, MN, 55440-1441, US

(21) Appl. No.: 10/895,437

(22) Filed: Mar. 3, 2004

(51) Int. Cl. B05B 1/00

(52) U.S. Cl. 239/597

(57) ABSTRACT

In a flat pattern air purge plural component spray device, the two side impingement ports in the mix chamber are offset slightly from the centerline of the central bore to provide enhanced mixing and better pattern control.

### TECHNICAL FIELD

This application claims the benefit of U.S. application Ser. No. ______, filed ______.

### BACKGROUND ART

Flat pattern air purge plural component spray devices are in general well known for mixing and spraying foams and polyureas. It is always desirable to improve the performance of such devices

### DISCLOSURE OF THE INVENTION

Towards this end, the two side impingement ports in the mix chamber are offset slightly from the centerline of the central bore. The direct-opposed arrangement of the prior art creates four quadrants of fluid flow circulation that continue and pass through the tip which shows up as uneven streams in the spray pattern. It has been discovered that offsetting the ports by too much can result in the creation of radial fluid velocity vectors at the exit which distort the straight line of the spray pattern. Applicants' discovery is that a slight offset will enhance mixing of the two materials without distortion of the spray pattern. The contents of PCT/US03/33422 are hereby incorporated by reference.

The inside spherical dome diameter of the tip interior matches the diameter of the mix chamber exit hole by providing a smooth transition to the tip exit cat-eye cut. This provides laminar flow for spraying and also produces a smooth path for the purge air to enhance tip cleaning.

The flat pattern tip V-cut has a wider flat bottom to enlarge the width of the pattern from traditional paint spray designs allowing a more uniform flow over the pattern length.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a top cross-section of the instant invention.

FIG. 2 is a side cross-section of the instant invention.

FIG. 3 is a side view of the tip of the instant invention.

FIG. 4 is an end view of the tip of the instant invention.

FIG. 5 is a cross-section of the mix chamber of the instant invention.

FIG. 6 is a perspective view of the mix chamber of the instant invention.

### BEST MODE FOR CARRYING OUT THE INVENTION

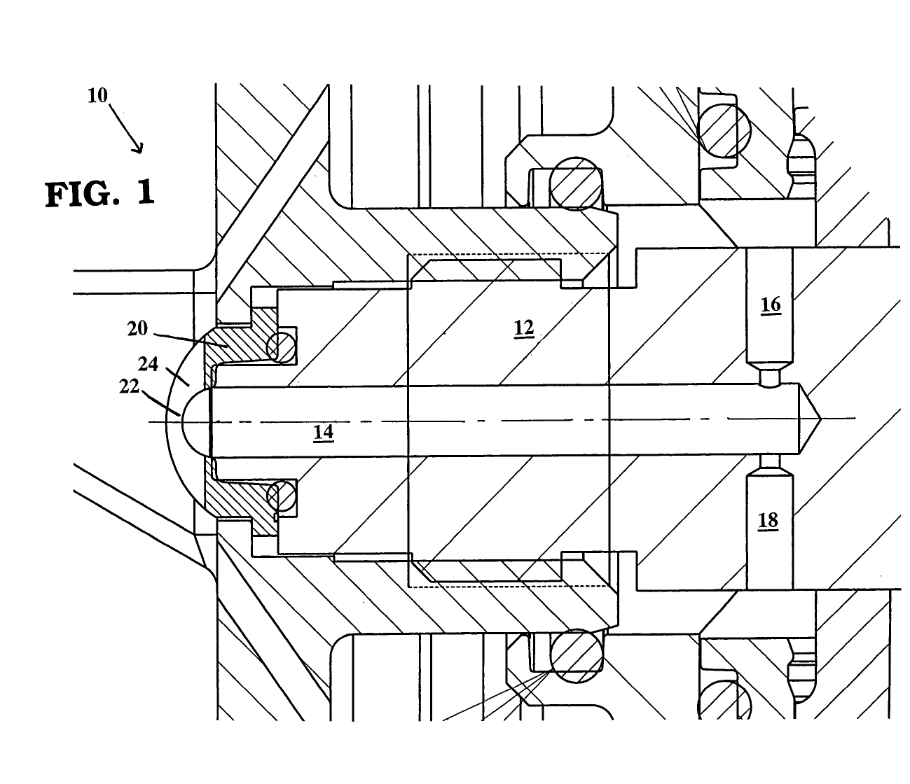

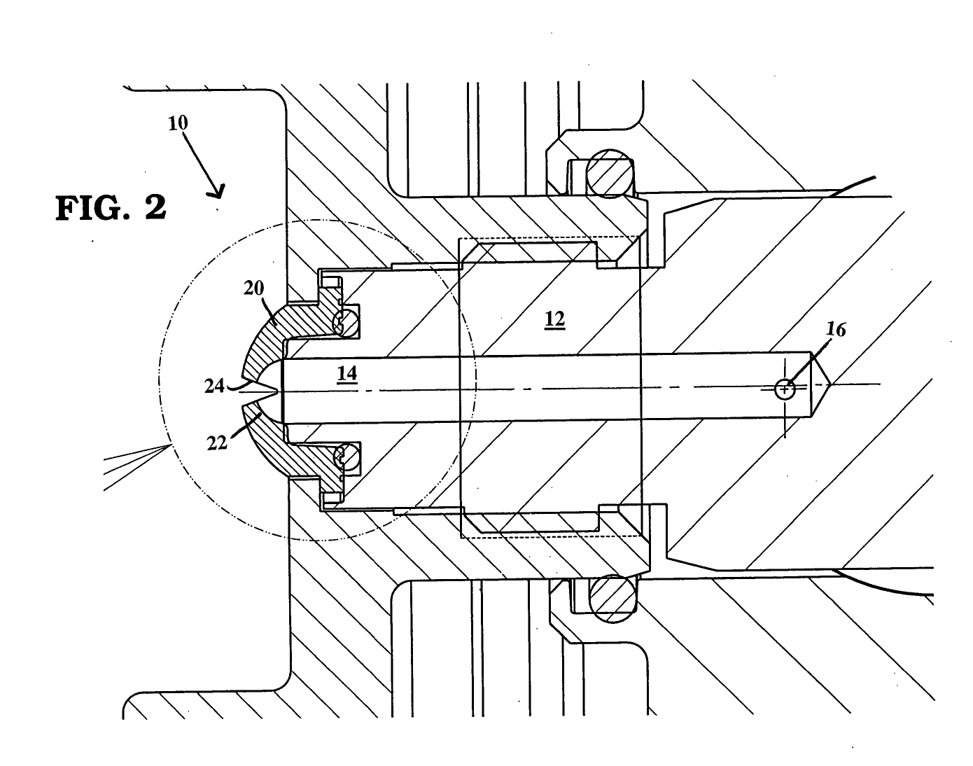

The instant invention, generally designated 10 is shown in FIGS. 1 and 2 and has a mix chamber 12 having a central bore 14 and first and second impingement ports 16 and 18. A tip 20 is secured to the front end of mix chamber 12 and is provided with an interior dome 22 and a V-cut 24.

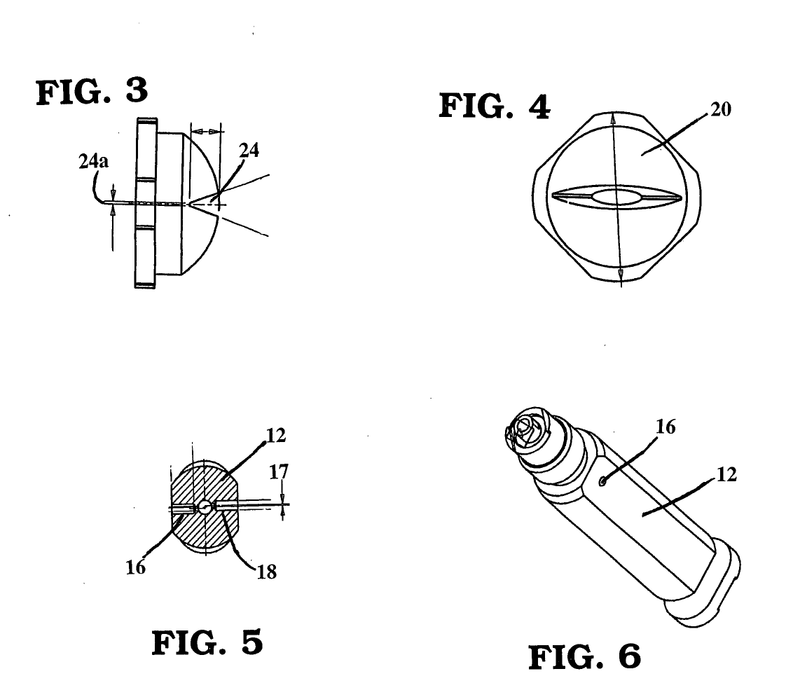

Tip 20 is shown in more detail in FIGS. 3 and 4. The diameter of the base of spherical dome 22 of the tip 20 interior matches the diameter of the mix chamber exit hole 14 by providing a smooth transition to the tip exit cat-eye cut 24. The angle of the V-cut may vary from 20° to 40° depending on the pattern desired. Importantly, the width of the base 24a of the V-cut 24 can vary from 0.005″ to 0.017″ in accordance with the angles mentioned above.

In the mix chamber 12, the offset 17 of the centerline of each impingement port (16 or 18) from the centerline of central bore 14 may vary from 0.005″ to 0.013″ to provide the critical results discussed above, the offset being but a fraction of the diameter of the impingement ports themselves.

It is contemplated that various changes and modifications may be made to the spray assembly without departing from the spirit and scope of the invention as defined by the following claims.

1. In an air purge plural component spray gun having a mix chamber with a central bore having a centerline and first and second impingement ports each having a centerline, the improvement comprising said first and second port centerlines each being offset from said bore centerline.

2. The air purge plural component spray gun of claim 1 wherein said offset is approximately 0.005″ to 0.013″.
